(19) United States
(12) Patent Application Publication
(10) Pub. No.: US 2006/0197024 A1
(43) Pub. Date: Sep. 7, 2006

(54) Apparatus and method for recording and determining the accuracy of predictions as to the occurrence of astronomical and atmospheric events

(76) Inventor: Jeffrey Manber, Alexandria, VA (US)

Correspondence Address: LUCAS & MERCANTI, LLP, 475 PARK AVENUE SOUTH, 15TH FLOOR, NEW YORK, NY, 10016, US

(21) Appl. No.: 11/369,258

(22) Filed: Mar. 7, 2006

Related U.S. Application Data
(60) Provisional application No. 60/659,311, filed on Mar. 7, 2005.
(60) Provisional application No. 60/659,314, filed on Mar. 7, 2005.

(51) Int. Cl. G01T 1/166

(52) U.S. Cl. 250/363.05

(57) ABSTRACT

Disclosed is a method and apparatus for recording and evaluating of the accuracy of predictions of random or unpredictable future events. The invention may be used for educational purposes and in games of chance. In one embodiment, it discloses a method and apparatus whereby a particular astronomical object or region of the natural sky is identified. The section of the sky so identified could be the surface of the sun or the night sky. This identification can be considered an “observation field” or “playing field” upon which gaming or study will take place. Superimposed upon this field is a geometric pattern, such as a grid, dividing the sky into pre-determined regions. The invention then compares actual events to predicted events and notifies the user if the user was or was not successful at predicting the event.

### CROSS-REFERENCE TO RELATED APPLICATIONS

This application is entitled to the benefit of U.S. Provisional Application Ser. No. 60/659,311, filed Mar. 7, 2005, and U.S. Provisional Application Ser. No. 60/659,314, filed Mar. 7, 2005. Such applications are incorporated herein by reference.

### STATEMENT REGARDING FEDERALLY SPONSORED RESEARCH OR DEVELOPMENT

Not applicable.

### BACKGROUND OF THE INVENTION

A. Field of the Invention

The present invention relates to astronomical and atmospheric events, and more particularly to the recording of predictions of such events and the determination of the accuracy of such predictions. The events include astronomical events that are essentially unpredictable, such as sunspots, solar flares, shooting stars, supernova explosions and the like, and atmospheric or other natural events that are essentially unpredictable, such as lightning strikes, Northern and Southern lights, hurricanes, tornadoes, earthquakes, volcanoes and other natural events. The invention is useful for measuring the accuracy of the prediction of future natural events, for use in education and for use in games of chance or contests.

B. Description of the Related Art

Astronomical events such as sunspots, solar flares, supernova explosions and the like have always fascinated scientists, science students and the general public. Major research work has been done in an attempt to predict such events. Some progress has been made, but today, such events still remain largely unpredictable.

Unpredictable events are the basis of the gaming industry. There has been an evolution in the gaming industry towards the introduction of novel and entertaining forms of traditional games of chance. Whether in lottery or keno or bingo or other games, the market has enjoyed a huge explosion in the variety of games. The consumer is becoming more jaded and often is no longer satisfied with a staple of one or two traditional products.

Several methods have been suggested for allowing novel variations on traditional games of chance such as, for example, that described in U.S. Pat. No. 6,236,900, in which participants can submit predictions of future events, obtain rewards for correct predictions and suffer penalties for incorrect predictions. In that patent, however, there is no attempt to present a graphic representation of the event; it is primarily guessing on when and if a certain event will take place.

There is also a very popular international game known as “Spot the Ball,” which imposes a grid on a photograph of a moment in soccer history. The soccer ball is then erased from the picture. The object of this game is for the players to guess, based on the soccer players shown in the photograph, the exact location of the soccer ball. The event in question has already taken place. It is not predictive, but based on historic occurrence. No attempt has been made to impose a grid or other geometric system on a live or recent astronomical, atmospheric or other natural event.

One aspect of natural events, whether they are sunspots, exploding supernova stars or lightning strikes, is their randomness. Unknown is when and where the next event will take place. While some theories exist as to the motion of such events after they appear, no one really knows exactly when or where one of these events will actually appear.

Methods of gaming on random future events exist today. Examples include predictions concerning the outcome of political elections and sporting events. There are multiple systems for such gaming. The events can be time- related, such as when a certain natural event, like the death of a famous person or the next hurricane to strike Florida, will take place.

Regardless of the chosen method, if a game of chance involving monetary wagering is involved, the wagering is predicated on the fact that the event in question is of interest to a large number of players, and yet the outcome is essentially “random,” or unknown, to anyone and hence allows players to wager based on factors including certain prior knowledge or just plain hunches.

Accordingly, there is a need in the art for novel systems and methods to incorporate an astronomical event or atmospheric event or other natural event with a grid system or other geometric pattern overlay system, allowing users to record predictions and later determine the accuracy of their predictions, and allowing wagers in games of chance or contests to take place in a style that is transparent and entertaining, or to allow students an opportunity to study astronomical or atmospheric phenomena in a novel way.

### SUMMARY OF THE INVENTION

The present invention discloses a new and novel manner for the evaluation of the accuracy of predictions of random future events, for use in education and in games of chance. More particularly, the invention discloses a system and method whereby a given prediction (sunspot activity, for example) is able to be tracked, recorded, quantified, measured and evaluated in graphical form.

In one embodiment, a particular region of the natural sky is identified by a game player, student or other individual. This identification could take place via any number of media, including but not limited to photograph, television, Internet Web sites, video images, mobile telephones, personal digital assistants (PDAs) or other devices. The section of the natural sky so identified could be the surface of the sun or the night sky. This identification can be considered the “playing field” or “observation field” upon which the gaming or study will take place. The method envisions superimposing upon this playing field some sort of geographical or geometric pattern, such as a rectangular grid, dividing the natural sky into pre-determined regions, value structures or labels, whether numbers or letters or any other assigned value.

One embodiment of the invention is directed to using a natural event taking place within an imposed grid to predict the resulting winning numbers, letters or any chance given designation along the grid.

Yet another aspect of the invention is directed to setting up a geometric pattern that would allow players to engage in a spatial contest, such as a bingo game where the pre-identified events inside the chosen region along the super-imposed “bingo board” produce the necessary components for this sort of game. Or it could be a dart board-type pattern that is superimposed over a region to allow players to engage in this sort of contest.

Systems and methods consistent with the principles of this invention address these and other needs by providing for a novel method for playing games of chance, and a novel method for studying natural events, in which the players or students are engaged in predicting where and when a particular astronomical or atmospheric event or series of events, will take place.

One aspect of the invention is directed to a device for recording a photograph or electronic image(s) of a particular region of natural sky.

The present invention allows for a wide variety of novel gaming, educational and study activities. Players, students and others can “predict” in what section of an overlaid grid a particular event or events will take place. Using this system, the result is a winning number, (representing a particular grid and hence location) a letter, or series of winning numbers or letters depending on the rules of the particular game. Players are able to either wage on the events or play a non-wagering contest. Those skilled in the art can envision many such arrangements for the games to take place.

Another aspect of the invention is a method for applying over the photographed or captured region a grid, or artificial geometric pattern, upon which is recorded numbers or other assigned values.

Another aspect of the invention is a method that applies rules to the collected data for the purposes of generating a “winner,” or identifying a student who has made the most accurate prediction.

Yet another aspect of the invention is directed to a mechanism by which the winning numbers or letters are transmitted quickly and accurately to the overall player or student audience.

More particularly, the invention comprises an apparatus for recording a prediction of a future astronomical event and for determining the accuracy of the prediction, comprising:
means for capturing and storing a first image of an astronomical object;
means for overlaying a geometrical pattern on the first image to define a plurality of first image areas;
means for receiving and storing a prediction from a user as to the occurrence of an astronomical event within a selected image area within a certain period of time;
means for capturing and storing a second image of the astronomical object after the passage of the period of time;
means for overlaying the geometrical pattern on the second image to define a plurality of second image areas;
means for determining whether the astronomical event has occurred in any of the second image areas and, if so, whether the astronomical event has occurred in the selected image area; and
means for notifying the user as to whether the astronomical event has occurred in the selected image area.

In another embodiment, the invention comprises an apparatus for recording a prediction of a future atmospheric event and for determining the accuracy of the prediction, comprising:
means for capturing and storing a first image of a selected region of the surface of a planetary body as viewed from space;
means for overlaying a geometrical pattern on the first image to define a plurality of first image areas;
means for accepting and storing a prediction from a user as to the occurrence of an atmospheric event within a selected image area within a certain period of time;
means for capturing and storing a second image of the selected region of the Earth's surface after the passage of the period of time;
means for overlaying the geometrical pattern on the second image to define a plurality of second image areas;
means for determining whether the atmospheric event has occurred in any of the second image areas and, if so, whether the atmospheric event has occurred in the selected image area during the period of time; and
means for notifying the user as to whether the atmospheric event has occurred in the selected image area.

In another embodiment, the invention comprises a method for recording a prediction of a future astronomical event and for determining the accuracy of the prediction, comprising the steps of:
capturing and storing a first image of an astronomical object;
overlaying a geometrical pattern on the first image to define a plurality of first image areas;
receiving and storing a prediction from a user as to the occurrence of an astronomical event within a selected image area within a certain period of time;
capturing and storing a second image of the astronomical object after the passage of the period of time;
overlaying the geometrical pattern on the second image to define a plurality of second image areas;
determining whether the astronomical event has occurred in any of the second image areas and, if so, whether the astronomical event has occurred in the selected image area; and
notifying the user as to whether the astronomical event has occurred in the selected image area.

In another embodiment, the invention comprises a method for recording a prediction of a future atmospheric event and for determining the accuracy of the prediction, comprising the steps of:
capturing and storing a first image of a selected region of the Earth's surface, as viewed from space;
overlaying a geometrical pattern on the first image to define a plurality of first image areas;
accepting and storing a prediction from a user as to the occurrence of an atmospheric event within a selected image area within a certain period of time;
capturing and storing a second image of the selected region of a planetary surface after the passage of the period of time;
overlaying the geometrical pattern on the second image to define a plurality of second image areas;
determining whether the atmospheric event has occurred in any of the second image areas and, if so, whether the atmospheric event has occurred in the selected image area during the period of time; and
notifying the user as to whether the atmospheric event has occurred in the selected image area.

In another embodiment, the invention comprises a method for operating a game of chance, the outcome of which is dependent upon the accuracy of a prediction of the occurrence of a future astronomical or atmospheric event, comprising the steps of:
capturing and storing a first image of an astronomical or atmospheric object;
   overlaying a geometrical pattern on the first image to define a plurality of first image areas;
   receiving and storing a prediction from a user as to the occurrence of an astronomical or atmospheric event within a selected image area within a certain period of time;
   capturing and storing a second image of the astronomical or atmospheric object after the passage of the period of time;
   overlaying the geometrical pattern on the second image to define a plurality of second image areas;
   determining whether the astronomical or atmospheric event has actually occurred in any of the second image areas and, if so, whether the astronomical or atmospheric event has occurred in the selected image area; and
   notifying the user as to whether the astronomical or atmospheric event has occurred in the selected image area within the period of time.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a series of photographs in reverse time sequence showing the sun with sunspots that change daily as the sun rotates;

FIG. 2 is a photograph of the sun with an overlaid grid pattern, and showing sunspots marked with “X” marks in certain grid cells;

FIG. 3 is a picture showing a partial map of Europe surrounded by marked grid lines, and also showing dark spots indicating the presence of recent lightning strikes;

FIG. 4 is a photograph of a region of the sky taken through a telescope, showing part of a galaxy and possible supernova events, and also surrounded by marked grid lines;

FIGS. 5A and 5B together show a flowchart illustrating the steps of one embodiment of the present invention, in particular as used in a game of chance; and

FIGS. 6A and 6B together show a flowchart illustrating the steps of another embodiment of the present invention, in particular as used in an educational environment.

### DETAILED DESCRIPTION OF THE INVENTION

The present invention is a method, apparatus, educational tool and game for predicting, measuring, studying and betting on naturally occurring and unpredictable astronomical, atmospheric and other natural events. Specifically, disclosed is the laying of a grid system for assigning pre-chosen numbers and other value coordinates atop astronomical and natural events, such as a live image of the sun, a live image of the earth, or of the night sky. Once the grid is superimposed atop the given image, and coordinates are assigned, players, students or others are invited to predict the coordinates of a defined event. It could be the location of sun spots in one week's time; it could be the location of lightning strikes above the earth; it could be the location of the next supernova, etc.

The following examples are provided to illuminate, but not limit, the present invention.

In one embodiment, employing data streams from existing scientific satellites, or otherwise available from the Intemet or databases, or directly from a telescope, the invention depicts a live image of the sun. This depiction takes place in several mediums, from television, to via the Internet, to the cell phone, or to a live screen. Preferably, these images are captured and saved in one or more computer memories or databases.

As is known, the sun usually has a number of sunspots. These spots are believed to be huge solar flares that explode out from the sun, sending large amounts of energy out into the solar system. This energy hurls itself through space and hits the upper atmosphere of the earth, which can disrupt satellite communications. This same energy also can cause what are known as the Northern Lights and Southern Lights.

Live astronomical and atmospheric images are available today from a number of public data sources. Lightning strikes can be monitored, for example at various Web sites, such as one maintained for Europe by the European Cooperation for Lightning Detection (EUCLID). Placing a grid over a region of Europe, a specific country for example, during a storm, allows players, students or others to predict or bet on which grids will have lightning strikes within them within a certain period of time. There are also more global, live or archived photos of the entire region. Alternatively, a user may use one's own satellite sensors for gathering the data.

Once a region is identified that will be the “observation field” or “playing field” for the invention, a grid or other geometric pattern is laid on top of the captured and defining image. The image is captured either directly from a camera attached to a telescope, or indirectly from other sources, such as from an Internet Web site maintained for astronomical research, or other databases, and then stored in another database.

Each square of the grid is identified in some fashion, whether by a number or a letter or combination thereof. Concurrently, a set of game rules or other framework is established, as in this example, the exact location (grid location) in which sun spots are predicted to occur at the end of a set period of time.

A game, or an observation period, is then started. Users make predictions as to which events will occur, when they will occur, and where they will occur. If wagering is involved, players wager on a single grid pattern (number value) in each quarter, or the adding up of all the grids (numbers) or any combination of other sort of pre-determined “winning” combinations.

The overlaid pattern may be either a grid of rectangular squares or other areas superimposed on the captured image, or a different pattern, such as circular areas, radial segments (like pieces of pie) or others.

The game or observation period is considered ended when the pre-determined or pre-selected time period is completed. The results of the observations or game are then communicated to the players or others. All players or other participants are able to view the results together with accompanying images.

More specifically, in one embodiment, the method of the present invention encompasses the following steps:

1. Select an astronomical, atmospheric or other natural object or region to observe.

2. Locate the object and point and focus a telescope on the object, or contact a Web site or database relating to the object.

3. Capture a first image of the object with a camera attached to the telescope, or from a Web site, database or other source.

4. Store the first image in a database.

5. Overlay a rectangular grid or other geometric pattern on the first image to define image areas, each image area being labeled or otherwise individually marked for identification.

6. Receive and record a selection by a user of a specific image area (location) in which a specified future event is predicted to occur within a specified period of time.

7. If a game is being played, query the user as to whether he or she wishes to place a bet as to whether the predicted future event will actually occur at the location and within the time period specified by the user, and, if the user indicates so, receive and record the bet.

8. Capture a second image of the object with a camera or from a Web site or database after passage of the specified time period.

9. Store the second image in a database.

10. Overlay the same geometric pattern used for the first image on the second image to define image areas substantially similar in pattern to the image areas defined for the first image.

11. Analyze the second image using image processing techniques.

12. Determine whether the event predicted by the user has actually occurred.

13. Determine at which location (image area) of the second image the actual event has occurred.

14. If the actual event location is the same as the predicted event location, within a certain margin of error, notify the user of a success or “win,” and pay off the bet, if any. If not, notify the user of a failure or “loss,” and keep the bet, if any.

15. Query the user as to whether he or she wishes to play again or make another observation. If so, return to step 1. Otherwise exit.

Preferably, all of the above steps are performed automatically by one or more computers or microprocessors operating under software control.

In another embodiment, the invention comprises a gaming apparatus and method in which the object of the game is to correctly predict the appearance and location of sunspots on the sun.

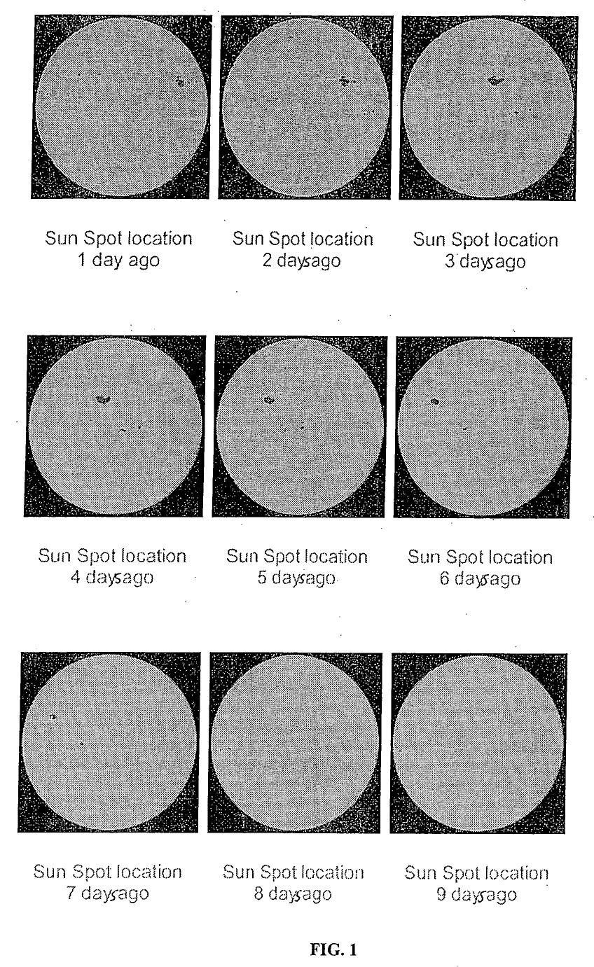

Turning now to the drawings, FIG. 1 is a series of photographs in reverse time sequence showing the sun with sunspots that change daily as the sun rotates. Current theories predict that the sun rotates at a certain rate, that sunspots tend to appear more often on certain regions of the sun's surface, that sunspots tend to appear more frequently every 11 years, and that sunspots tend to appear in pairs, but the current theories cannot yet predict precisely when or where sunspots will actually appear.

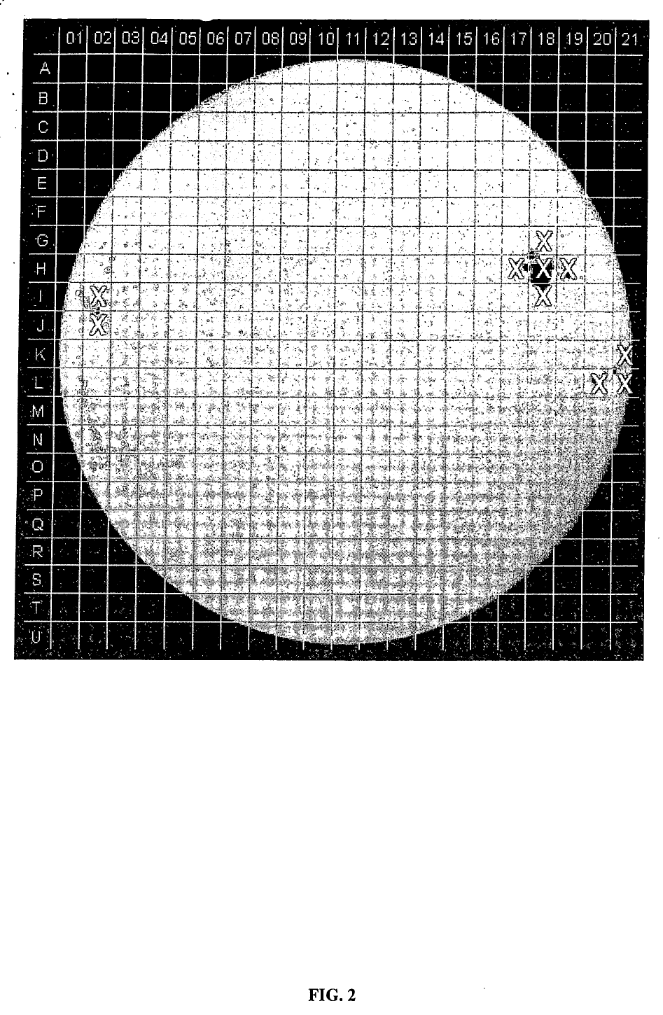

FIG. 2 is a photograph of the sun with an overlaid grid pattern, and showing sunspots marked with “X” marks in certain grid cells.

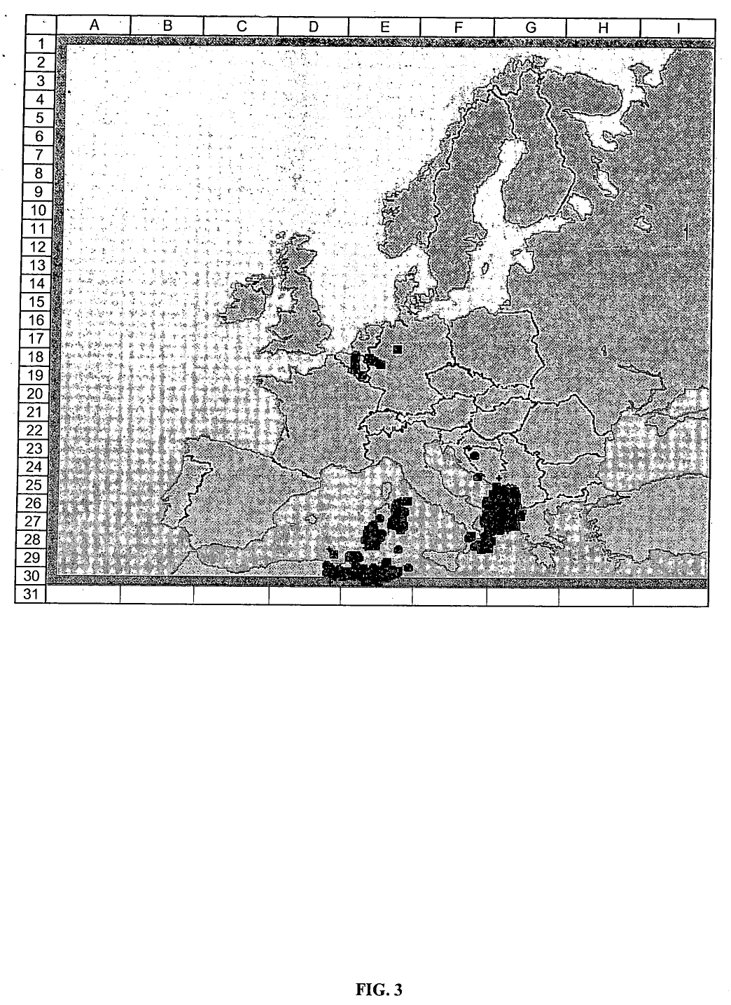

FIG. 3 is a picture showing a partial map of Europe surrounded by marked grid borders, and also showing dark spots indicating the presence of recent lightning strikes.

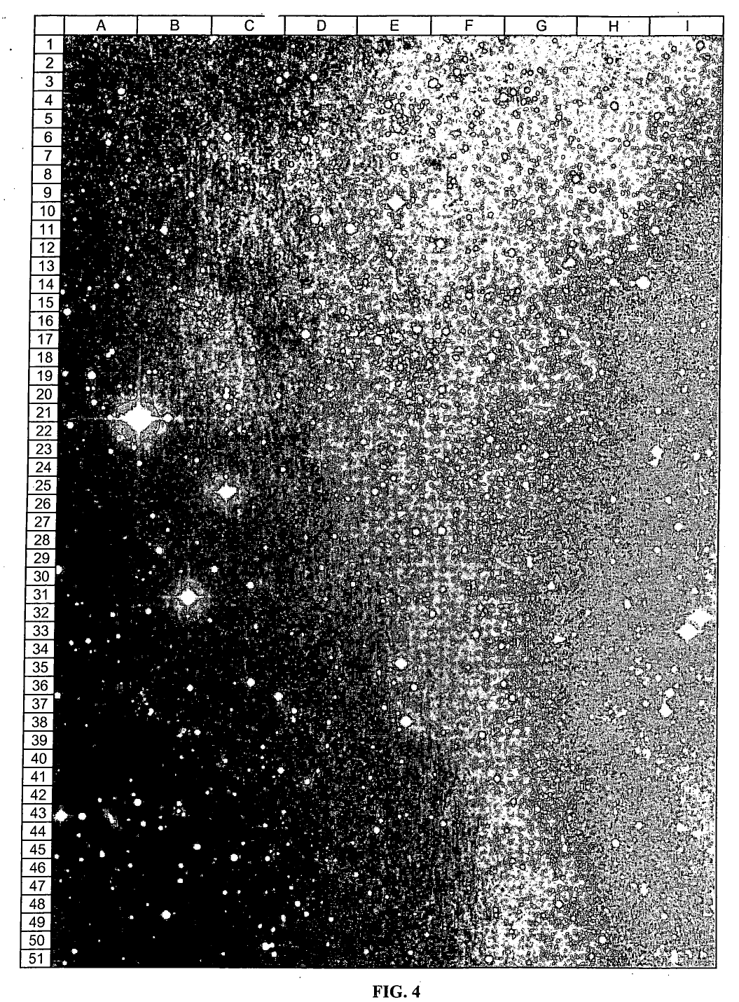

FIG. 4 is a photograph of a region of the sky taken through a telescope, showing part of a galaxy and possible supernova events, and also surrounded by marked grid borders.

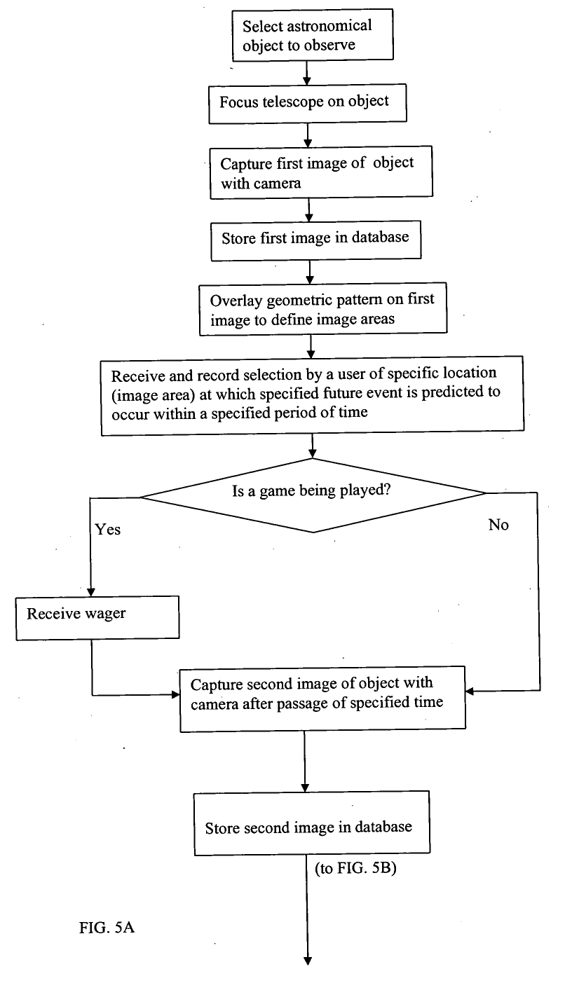

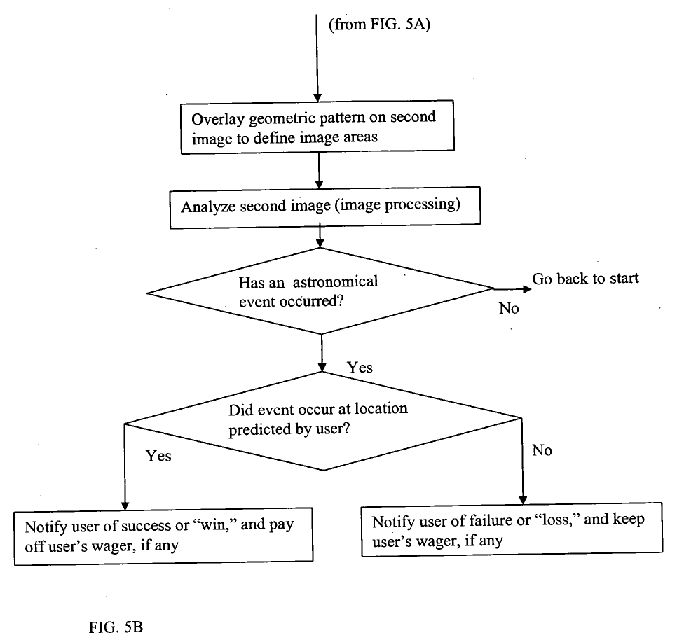

FIGS. 5A and 5B together show a flowchart illustrating the steps of one embodiment of the present invention, in particular as used in a game of chance.

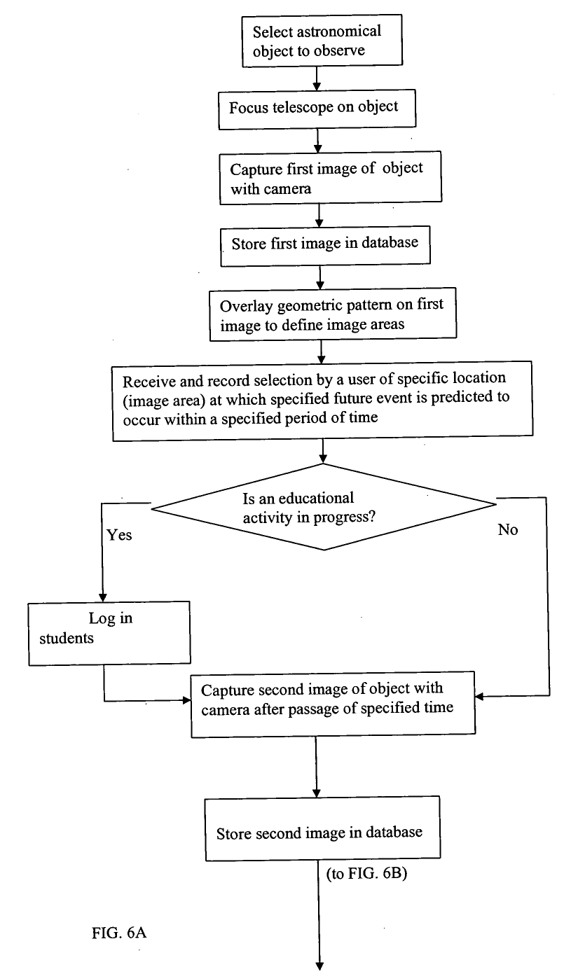

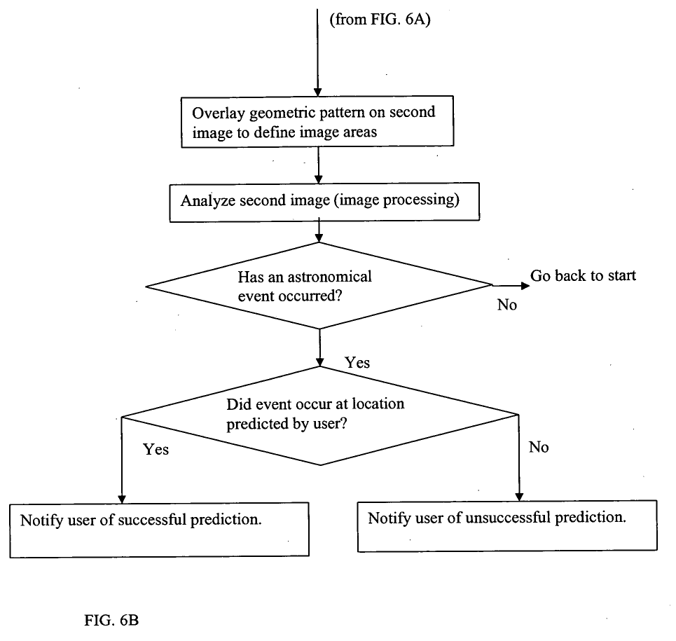

FIGS. 6A and 6B together show a flowchart illustrating the steps of another embodiment of the present invention, in particular as used in an educational environment.

The present invention has several applications. For example, it may be used in an educational environment in which science students are studying the sun or other astronomical or atmospheric events. A grid system, as here, is easily employed as an educational tool. For example, a professor may ask students to study the motion of sunspots over time to test the validity of theories on the formation, location, movement and timing of sunspots. Other solar events, patterns and cycles, such as the solar wind, flares, coronal mass ejections and other events can also be tracked and tested using a grid pattern overlaid on the sun. Some of these solar events affect the Earth, such as in aurora displays and in occasional satellite communication or power grid disruptions, so they are important educational tools.

Another application of the invention involves games of chance or contests. The following is one example of on-screen text dialog messages that may be used for a Sun Spot Game of chance using the invention:

“To play the Sun Spot Game:

1) take a close look at the grid of the sun.

2) decide for yourself where, in one week's time, will be the sun spots on the sun. Both those we can see today and new ones that might form.

3) enter the numbers and letters equaling the places where you think the sun spots will be.

4) THEN also enter how many boxes will have sun spots.

The combination of the two—the location and size of the sun spots—determine the winning entry.

The top entry will win $______

The second closest will win $______

The third closest will win $______

Place your bet as to the location of any sun spot and the total number of squares containing sun spots. Bets stop the Sunday before the event of the following Saturday at 12.00 GMT. Alternatively, bets must stop one day before the expiration of the time period chosen below.

The “X” indicates a winning square. In the current example shown in the diagram (FIG. 2), there are currently 10 squares containing sun spots.

WARNING: Never look directly at the Sun.

Horizontal grid reference: ______ (pick up to 20):

A B C D E F G H I J K L M N 0 P Q R S T”

Vertical grid reference: ______ (pick up to 20):

1 2 3 4 5 6 7 8 9 10 11 12 13 14 15 16 17 18 19 20

How many sun spots: ______ (pick up to 20):

0 1 2 3 4 5 6 7 8 9 10 11 12 13 14 15 16 17 18 19 20

Preferred time period (enter number and pick one):

______ days; ______ weeks; ______ months; ______ years

Size of Bet in US Dollars: $______

Credit Card Information: ______

To Play Now, click here:_____”

After the user has submitted the prediction and/or “bet,” then the system performs automatically from that point forward. When the designated specified time has passed, the system will automatically take another image of the sun and analyze it to determine whether any predicted sunspots have actually appeared within the specified time and, if so, whether they have appeared at the exact location(s) predicted by the user. If so, the user is congratulated on his or her successful prediction and declared a “winner,” and any bets are paid off. If not, the system retains the bets. In the alternative, in an educational environment, each participating student could be given a “grade” depending upon how successful their predictions were.

While the invention has been described herein with reference to certain preferred embodiments, these embodiments have been presented by way of example only, and not to limit the scope of the invention.

What is claimed is:

1. An apparatus for recording a prediction of a future astronomical event and for determining the accuracy of the prediction, comprising:
means for capturing and storing a first image of an astronomical object;
means for overlaying a geometrical pattern on the first image to define a plurality of first image areas;
means for receiving and storing a prediction from a user as to the occurrence of an astronomical event within a selected image area within a certain period of time;
means for capturing and storing a second image of the astronomical object after the passage of the period of time;
means for overlaying the geometrical pattern on the second image to define a plurality of second image areas;
means for determining whether the astronomical event has occurred in any of the second image areas and, if so, whether the astronomical event has occurred in the selected image area; and
means for notifying the user as to whether the astronomical event has occurred in the selected image area.

2. The apparatus of claim 1, in which the astronomical object is the sun, and the astronomical event is a sunspot.

3. The apparatus of claim 1, in which the astronomical object is a selected region of the sky, and the astronomical event is a supernova.

4. The apparatus of claim 1, in which the astronomical object is a selected region of the sky, and the astronomical event is a shooting star.

5. The apparatus of claim 1, in which the geometric pattern is a grid of rectangular areas, each area having a separate identifying label.

6. The apparatus of claim 1, in which the geometric pattern is a pattern of circular areas, each area having a separate identifying label.

7. An apparatus for recording a prediction of a future atmospheric event and for determining the accuracy of the prediction, comprising:
means for capturing and storing a first image of a selected region of the Earth's surface, as viewed from space;
means for overlaying a geometrical pattern on the first image to define a plurality of first image areas;
means for accepting and storing a prediction from a user as to the occurrence of an atmospheric event within a selected image area within a certain period of time;
means for capturing and storing a second image of the selected region of the Earth's surface after the passage of the period of time;
means for overlaying the geometrical pattern on the second image to define a plurality of second image areas;
means for determining whether the atmospheric event has occurred in any of the second image areas and, if so, whether the atmospheric event has occurred in the selected image area during the period of time; and
means for notifying the user as to whether the atmospheric event has occurred in the selected image area.

8. The apparatus of claim 7, in which the atmospheric event is a lightning strike.

9. A method for recording a prediction of a future astronomical event and for determining the accuracy of the prediction, comprising the steps of:
capturing and storing a first image of an astronomical object;
overlaying a geometrical pattern on the first image to define a plurality of first image areas;
receiving and storing a prediction from a user as to the occurrence of an astronomical event within a selected image area within a certain period of time;
capturing and storing a second image of the astronomical object after the passage of the period of time;
overlaying the geometrical pattern on the second image to define a plurality of second image areas;
determining whether the astronomical event has occurred in any of the second image areas and, if so, whether the astronomical event has occurred in the selected image area; and
notifying the user as to whether the astronomical event has occurred in the selected image area.

10. The method of claim 9, in which the astronomical object is the sun, and the astronomical event is a sunspot.

11. The method of claim 9, in which the astronomical object is a selected region of the sky, and the astronomical event is a supernova.

12. The method of claim 9, in which the astronomical object is a selected region of the sky, and the astronomical event is a shooting star.

13. The method of claim 9, in which the geometric pattern is a grid of rectangular areas, each area having a separate identifying label.

14. The method of claim 9, in which the geometric pattern is a pattern of circular areas, each area having a separate identifying label.

15. A method for recording a prediction of a future atmospheric event and for determining the accuracy of the prediction, comprising the steps of:
capturing and storing a first image of a selected region of the surface of a planetary body, as viewed from space;
overlaying a geometrical pattern on the first image to define a plurality of first image areas;
accepting and storing a prediction from a user as to the occurrence of an atmospheric event within a selected image area within a certain period of time;
capturing and storing a second image of the selected region of the planetary body's surface after the passage of the period of time;
overlaying the geometrical pattern on the second image to define a plurality of second image areas;
determining whether the atmospheric event has occurred in any of the second image areas and, if so, whether the atmospheric event has occurred in the selected image area during the period of time; and
notifying the user as to whether the atmospheric event has occurred in the selected image area.

16. The method of claim 15, in which the atmospheric event is a lightning strike.

17. A method for operating a game of chance, the outcome of which is dependent upon the accuracy of a prediction of the occurrence of a future astronomical or atmospheric event, comprising the steps of:
capturing and storing a first image of an astronomical or atmospheric object;
overlaying a geometrical pattern on the first image to define a plurality of first image areas;
receiving and storing a prediction from a user as to the occurrence of an astronomical event within a selected image area within a certain period of time;
capturing and storing a second image of the astronomical or atmospheric object after the passage of the period of time;
overlaying the geometrical pattern on the second image to define a plurality of second image areas;
determining whether the astronomical or atmospheric event has actually occurred in any of the second image areas and, if so, whether the astronomical or atmospheric event has occurred in the selected image area; and
notifying the user as to whether the astronomical or atmospheric event has occurred in the selected image area within the period of time.
